(19) United States
(12) Patent Application Publication
(10) Pub. No.: US 2011/0117314 A1
(43) Pub. Date: May 19, 2011

(54) CONSOLE CARPET

(75) Inventors: Lauren Michelle Marzolf, Superior Twp, MI (US); Chandan Chahande, Troy, MI (US)

(73) Assignee: Toyota Motor Engineering & Manufacturing North America, Inc., Erlanger, KY (US)

(21) Appl. No.: 12/619,916

(22) Filed: Nov. 17, 2009

(51) Int. Cl. B32B 33/00

(52) U.S. Cl. 428/95

(57) ABSTRACT

The present invention discloses a carpeted panel having a durable and flexible carpet attached thereto. The panel has a top surface, a bottom surface, and an edge between the top surface and the bottom surface A three-layer carpet is also provided, the three-layer carpet having a latex substrate layer, a fiber layer extending across and attached to one side of the substrate layer, and an adhesive layer extending across and attached to an opposite side of the substrate layer. The adhesive layer firmly attaches the three-layer carpet to the top surface, around the edge and onto the bottom surface of the panel. In addition, the fiber layer covers the latex substrate layer such that the substrate layer is not visible when viewed from the fiber layer side proximate to the edge of the panel.

### FIELD OF THE INVENTION

The present invention relates to a console carpet and in particular to a durable and flexible console carpet for use in a motor vehicle.

### BACKGROUND OF THE INVENTION

Carpet is typically a molded laminated product composed of a tufted or nonwoven fibers attached to a base substrate. Tufted carpet generally includes a composite structure in which tufts or bundles of carpet fiber are introduced into a primary backing such as a woven or nonwoven fabric. A secondary backing or coating of thermoplastic material is subsequently applied to the underside of the carpet construction and securely retains the tufted material in the primary backing. The secondary backing also provides dimensional stability, greater abrasion and wear resistance, and may serve as an adhesive for an additional layer of material.

Motor vehicle carpeting is typically molded into a nonplanar contour configuration that conforms with contours of the motor vehicle floor. However, such carpeting is relatively thick and is not suitable for fitting within or wrapping around tight corners. In the alternative, heretofore thin carpeting that has been able to wrap around tight corners has exposed a base or substrate layer through a fiber layer when viewed from the fiber layer side proximate to an edge or corner that the carpet is wrapped around. This exposure of the base or substrate layer is unsightly and undesirable to motor vehicle manufacturers. In addition, heretofor thin carpets have not provided desirable abrasion and wear resistance. Therefore, a durable and flexible carpet that provides adequate abrasion and wear resistance and yet can wrap around tight corners without exposure of a base or substrate layer is desirable.

### SUMMARY OF THE INVENTION

The present invention discloses a carpeted panel having a durable and flexible carpet attached thereto. The panel has a top surface, a bottom surface, and an edge between the top surface and the bottom surface. In some instances, the panel can have a thickness of less than 5 millimeters. A three-layer carpet is also provided, the three-layer carpet having a latex substrate layer, a fiber layer extending across and attached to one side of the substrate layer, and an adhesive layer extending across and attached to an opposite side of the substrate layer.

The three-layer carpet extends across the top surface, around the edge and at least part of the bottom surface of the panel. In addition, the adhesive layer firmly attaches the three-layer carpet to the panel, and the fiber layer covers the latex substrate layer such that the substrate layer is not visible when viewed from the fiber layer side proximate to the edge of the panel. The panel with the three-layer carpet attached thereto can be an interior panel within an interior of a motor vehicle, and the interior panel can abut against a floor carpeting of the motor vehicle. In addition, the interior panel can be a floor panel for a sliding console of the motor vehicle.

The latex substrate layer can be an acrylic latex layer and be made from acrylic styrene latex, acrylic butadiene latex, and/or acrylic styrene-butadiene latex. The fibers can be made from nylon, polypropylene, polyester, polyacrylonitrile, wool, and/or cotton. Finally, the adhesive layer can be made from an adhesive such as a synthetic rubber and resin blend, an acrylic polymer blend, and/or an amide-ester-acrylate resin blend.

The latex substrate layer can have a thickness between 0.5 to 1.5 millimeters, the fiber layer can have a thickness of between 2 to 6 millimeters, and the adhesive layer can have a thickness of between 0.1 to 0.5 millimeters. In some instances, the latex substrate layer has a thickness between 0.7 to 1.1 millimeters, the fiber layer has a thickness of between 2 to 3 millimeters, and the adhesive layer has a thickness of between 0.14 to 0.32 millimeters.

### BRIEF DESCRIPTION OF THE DRAWINGS

FIG. 1 is an exploded perspective view of a sliding console for a motor vehicle;

FIG. 2 is a perspective view of the sliding console shown in FIG. 1 attached to a console rail of the motor vehicle;

FIG. 3 is a perspective view of the sliding console shown in FIG. 1 with an additional cover panel attached to the console slide rail;

FIG. 4 is a side cross-sectional view of a three-layer carpet according to an embodiment of the present invention;

FIG. 5 is a side cross-sectional view of section 5-5 shown in FIG. 3; and

FIG. 6 is an end cross-section view of section 6-6 shown in FIG. 3.

### DETAILED DESCRIPTION OF THE INVENTION

The present invention discloses a durable and flexible three-layer carpet for attaching and wrapping around tight corners of a structure. As such, the carpet has utility as a cover material within a motor vehicle.

The three-layer carpet can include an acrylic latex substrate layer, a fiber layer extending across and attached to one side of the substrate layer, and an adhesive layer extending across and attached to an opposite side of the substrate layer. The three-layer carpet can wrap around and attach to a panel having a thickness between 2 and 4 millimeters, inclusive, the substrate layer not being visible through the fiber layer when viewed from the fiber layer side proximate to the edge of the panel. Naturally, a panel having a thickness between 2 and 4 millimeters can be included.

In some instances, the panel with the three-layer carpet attached thereto is an interior panel within a motor vehicle interior, and the interior panel may or may not abut against floor carpeting. The acrylic latex substrate layer can be made from acrylic styrene latex, acrylic butadiene latex, and/or acrylic styrene-butadiene latex. In addition, the fibers can be made from nylon, polypropylene, polyester, polyacrylonitrile, wool, and/or cotton. The adhesive layer that attaches the three-layer carpet to the panel can be made from a synthetic rubber and resin blend, an acrylic polymer blend, and/or an amide-ester-acrylate resin blend.

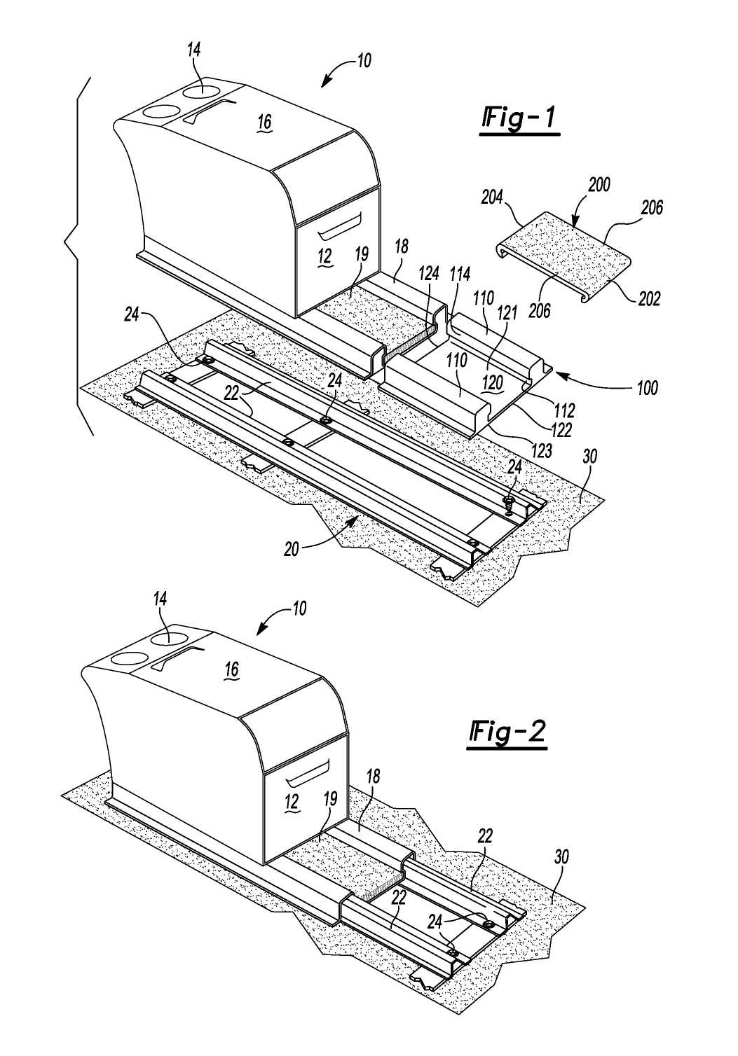

Turning now to FIG. 1, an exploded perspective view of a sliding console for a motor vehicle is shown generally at reference numeral 10. The console 10 can include a sliding drawer 12, a beverage container 14, and a top compartment door 16. The console 10 can also include a rail tray cover 18 that is shaped to fit around and cover a console slide rail structure 20 that can attach to a floor. It is appreciated that the console rail structure 20 can afford for the console 10 to be attached thereto and thus be securely attached to a frame, white body, etc., of a motor vehicle. In addition, a floor carpet 30 can surround the sliding console 10 as shown in the figure.

Also shown in FIG. 1 is a separate cover panel 100 and a piece of carpet 200. The cover panel 100 can be provided to cover the console rail structure 20 after the console 10 has been attached to the structure 20, a frame, whitebody, etc. The cover panel 100 can have one or more rail covers 110 and a main rail bracket cover portion 120 having a top surface 121 and a bottom surface 123. Extending between the top surface 121 and the bottom surface 123 can be an edge 122 and/or an oppositely disposed edge 124. The rail cover 110 can have a side wall 114 that provides an indentation or a groove 112 within which at least part of the carpet 200 can fit. In this manner, side edge regions 206 of the carpet 200 can fit within the groove 112 and thud not be visible to the eye of an individual sitting in the motor vehicle. The carpet 200 can have a first end 202 and a second end 204, the carpet having three layers and being of sufficient flexibility such that the ends 202, 204 can wrap around the ends 122, 124 of the cover panel 100.

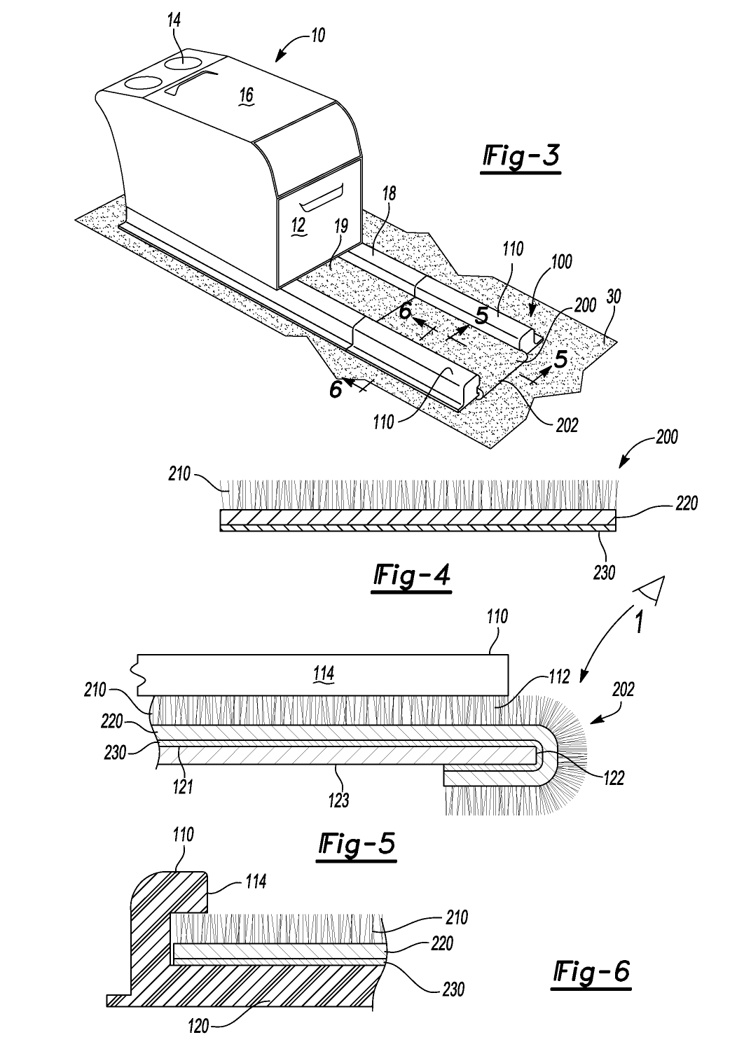

Looking now at FIG. 2, the console 10 has been placed over and is attached to the console rail structure 20. FIG. 3 illustrates the cover panel 100 also in place over the console rail structure 20 such that the carpet 200 abuts against a console tray carpeting 19 covering a console tray and provides a smooth transition between the two carpeted surfaces. In addition, the carpet 200 can be placed on and attached to the cover panel 100 at any point before its installation onto the support structure 20. In this manner, a more effective and cost-efficient cover panel 100 with carpet 200 is provided.

Turning now to FIGS. 4-6, a cross-sectional view of the carpet 200 is shown. FIG. 4 illustrates three distinct layers of the carpet 200: a fiber layer 210; a substrate layer 220; and an adhesive layer 230. The fibers can be needle punched or tufted into the substrate layer 220 and may or may not be made from nylon, polypropylene, polyester, polyacrylonitrile, wool, and/or cotton. Preferably, the fibers are needle punched into the substrate layer 220. In addition, the substrate layer can be an acrylic latex such as an acrylic styrene latex, an acrylic butadiene latex, and/or an acrylic styrene-butadiene latex material. The adhesive can be made from a synthetic rubber and resin blend, an acrylic polymer blend, and/or an amide-ester-acrylate resin blend. As shown in the figure, the fiber layer can be attached to one side of the substrate 220 while the adhesive layer 230 is attached to an opposite side of the substrate 220. In addition, it is appreciated that a nonstick backing (not shown) can be present and adjacent to the adhesive layer 230 before it is removed and the carpet 200 is attached to a panel.

Looking particularly at FIGS. 5 and 6, these figures illustrate the carpet 200 attached to the top surface 121, bottom surface 123, and edge 122 of the cover panel 100. The carpet 200 can fit within the groove 112 of the rail 110 and the side edge regions 204 hidden from view from an individual. It is appreciated that placing the side edge regions 204 within the groove 112 can also allow the underside of these regions to not be adhesively attached to the cover panel 100, and yet the panel with carpet can still appear aesthetically pleasing to an individual. In this manner, assembly of the carpet onto the panel 100 can be more time and cost efficient. It is further appreciated that the fiber layer 210 is dense enough such that separation of the fibers does not occur to the extent that the substrate layer 220 is visible when viewed from a fiber layer side proximate to the end 122 of the panel as illustrated by the directional arrow 1.

In some instances, the panel 120 can have a thickness less between and 4 millimeters, inclusive. In addition, the acrylic latex substrate layer 220 can have a thickness between 0.5 to 1.5 millimeters, the fiber layer 210 can have a thickness, also known as a pile height, of between 2 to 6 millimeters, and the adhesive layer 230 can have a thickness between 0.1 to 0.4 millimeters, all inclusive. In other instances, the acrylic latex substrate layer 220 can have a thickness between 0.7 to 1.1 millimeters, the fiber layer can have a pile height of between 2 to 3 millimeters, and the adhesive layer can have a thickness of between 0.14 to 0.32 millimeters. It still other instances, the fiber layer can have a pile height of generally 2.4 millimeters which is approximately half of a typical 4.8 millimeter pile height for heretofor automotive carpets.

Although the carpet 200 is shown as wrapping around an edge 122, it is appreciated that the carpet 200 can be used to fit within tight spaces, fit snugly within 90 degree corners, and the like. It is further appreciated that the carpet 200 provides adequate abrasion and wear resistance to meet automotive standards known to those skilled in the art and yet provide a lower cost alternative to standard automotive floor carpeting.

The invention is not restricted to the illustrative embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the claims.

I claim:

1. A carpeted panel having a durable and flexible carpet attached thereto, said carpeted panel comprising:
a panel having a top surface, bottom surface, and an edge between said top surface and said bottom surface;
a three-layer carpet having:
a latex substrate layer;
a fiber layer extending across and attached to one side of said substrate layer; and
an adhesive layer extending across and attached to an opposite side of said substrate layer;
said three-layer carpet extending across and attached to said top surface around said edge and at least part of said bottom surface of said panel;
wherein said adhesive layer attaches said three-layer carpet to said panel and said fiber layer covers said latex substrate layer such that said substrate layer is not visible when viewed from said fiber layer side proximate said edge of said panel.

2. The carpeted panel of claim 1, wherein said panel with said three-layer carpet attached thereto is an interior panel within an interior of a motor vehicle.

3. The carpeted panel of claim 2, wherein said interior panel abuts against a floor carpeting in the motor vehicle.

4. The carpeted panel of claim 3, wherein said interior panel is a floor panel for a sliding console of the motor vehicle.

5. The carpeted panel of claim 1, wherein said acrylic latex substrate layer is selected from the group consisting of an acrylic styrene latex substrate layer, an acrylic butadiene latex substrate layer, and an acrylic styrene-butadiene latex substrate layer.

6. The carpeted panel of claim 1, wherein said fiber layer is made from fibers selected from the group consisting of nylon, polypropylene, polyester, polyacrylonitrile, wool, and cotton.

7. The carpeted panel of claim 1, wherein said adhesive layer is made from an adhesive selected from the group consisting of a synthetic rubber and resin blend, an acrylic polymer blend, and an amide-ester-acrylate resin blend.

8. The carpeted panel of claim 1, wherein said acrylic latex substrate layer has a thickness between 0.5 to 1.5 millimeters, said fiber layer has a thickness of between 2 to 6 millimeters, and said adhesive layer has a thickness of between 0.1 to 0.4 millimeters.

9. The carpeted panel of claim 8, wherein said acrylic latex substrate layer has a thickness between 0.7 to 1.1 millimeters, said fiber layer has a thickness of between 2 to 3 millimeters, and said adhesive layer has a thickness of between 0.14 to 0.32 millimeters.

10. The carpeted panel of claim 1, wherein said panel has a thickness of less than 4 millimeters.

11. A durable and flexible three-layer carpet for attaching and wrapping around tight corners of a structure, said three-layer carpet comprising:
an acrylic latex substrate layer;
a polyethylene fiber layer extending across and attached to one side of said substrate layer; and
an adhesive layer extending across and attached to an opposite side of said substrate layer;
wherein said three-layer carpet can wrap around and attach to a panel and said substrate layer is not visible through said fiber layer when viewed from said fiber layer side proximate said edge of said panel.

12. The three-layer carpet of claim 11, further comprising a panel having a top surface, bottom surface, and an edge between said top surface and said bottom surface, said panel also having a pair of spaced apart rail covers extending upwardly from said top surface, each of said pair of spaced apart rail covers having a groove adjacent said top surface of said panel;
wherein said panel has a thickness of less than 4 millimeters, inclusive, said adhesive layer attaches said three-layer carpet to said top surface, said bottom surface and said edge of said panel, and said fiber layer covers said latex substrate layer such that said substrate layer is not visible when viewed from said fiber layer side proximate said edge of said panel.

13. The three-layer carpet of claim 12, wherein said panel with said three-layer carpet attached thereto is an interior panel within an interior of a motor vehicle.

14. The three-layer carpet of claim 13, wherein a pair of spaced apart side edge regions are of said three-layer carpet are each located within one of said grooves.

15. The three-layer carpet of claim 14, wherein said interior panel is a floor panel for a sliding console of the motor vehicle.

16. The three-layer carpet of claim 11, wherein said acrylic latex substrate layer is selected from the group consisting of an acrylic styrene latex substrate layer, an acrylic butadiene latex substrate layer, and an acrylic styrene-butadiene latex substrate layer.

17. The three-layer carpet of claim 11, wherein said fiber layer is made from fibers selected from the group consisting of nylon, polypropylene, polyester, polyacrylonitrile, wool, and cotton.

18. The three-layer carpet of claim 11, wherein said adhesive layer is made from an adhesive selected from the group consisting of a synthetic rubber and resin blend, an acrylic polymer blend, and an amide-ester-acrylate resin blend.

19. The three-layer carpet of claim 11, wherein said acrylic latex substrate layer has a thickness between 0.5 to 1.5 millimeters, said fiber layer has a thickness of between 2 to 6 millimeters, and said adhesive layer has a thickness of between 0.1 to 0.4 millimeters.

20. The three-layer carpet of claim 11, wherein said acrylic latex substrate layer has a thickness between 0.7 to 1.1 millimeters, said fiber layer has a thickness of between 2 to 3 millimeters, and said adhesive layer has a thickness of between 0.14 to 0.32 millimeters.
